(19) United States
(12) Patent Application Publication
(10) Pub. No.: US 2014/0070002 A1
(43) Pub. Date: Mar. 13, 2014

(54) SYSTEM AND METHOD FOR PRINTER OPERATION BASED ON USER PROXIMITY

(71) Applicants: Stephen Pineau, Richmond (CA); Ola Wiberg, Cloverdale (CA); David Lee, Vancouver (CA); Shayne Peter Bates, Fairfax, VA (US); Steven Chand, Surrey (CA)

(72) Inventors: Stephen Pineau, Richmond (CA); Ola Wiberg, Cloverdale (CA); David Lee, Vancouver (CA); Shayne Peter Bates, Fairfax, VA (US); Steven Chand, Surrey (CA)

(73) Assignee: VISCOUNT SYSTEMS INC., Burnaby (CA)

(21) Appl. No.: 13/607,654

(22) Filed: Sep. 7, 2012

(51) Int. Cl. G06K 5/00

(52) U.S. Cl. CPC G06K 5/00
USPC 235/382

(57) ABSTRACT

Secure, shared operation of a group printer is made possible by tagging a printer with an unpowered, unique, identifying token which can be read by a user's personal mobile electronic device. The user's device transmits both printer and user identification to a remote server or computer, from which a command to start the printer is issued. Commands may be sent using the IP suite of protocols. The system may also support single-use digital tokens to allow users external to the group to print on an occasional basis.

### TECHNICAL FIELD

The present invention generally relates to the field of securing printer operation so that it is dependent on the user being in proximity to the printer. More particularly, it is concerned with a system, method and database for determining that users are located close by printers before they start to print, using local printer identifying tokens and personal mobile devices as readers, which communicate via a network that uses the Internet Protocol (IP).

### BACKGROUND

In many cases, a printer is shared with a group of people, whether it be in a business, a government department, a charity or other type of group. Such a printer is usually located at a distance from many of the users in the group. Often, a user of the printer may need to print a confidential document which should not be seen by other people in the group that are sharing the printer. In these cases, there is a risk that the user might forget that the document has been sent to the printer, and the risk that the user might be distracted before being able to retrieve the printed document. As a result, there is a possibility that other, unauthorized members of the group may see and read the document.

### SUMMARY OF INVENTION

The present invention may be used to facilitate the secure printing of confidential documents on a shared printer, which is located out of sight or at a distance from the users who wish to print the documents. This is achieved by attaching a token to the printer, which contains a unique identifier of the printer. When the user sends a print command to the printer from a personal computer, the printer only starts printing when the user provides confirmation that he is in the vicinity of the printer. Confirmation is provided by the user detecting the printer identifier with a personal mobile electronic device and sending the detected printer identifier via a network to a computer or computer system that controls the printer. The token may be a QR code, an NFC chip or any other device that can contain an identifier of a printer.

Disclosed herein is a system for controlling printers comprising: a printer; an unpowered token comprising an identifier for, and located in the vicinity of, the printer; and a computer connected to the printer and configured to generate commands for the printer; wherein the computer is configured to: receive an instruction to print a document; receive, from a personal mobile electronic device located in the vicinity of the printer, the identifier and an identification of the personal mobile electronic device; check whether the identification is valid; and if the identification is valid, transmit a command to the printer to cause it to start printing the document.

Further disclosed is a method for controlling printers comprising: receiving, by a computer remote from a printer, an instruction to print a document; receiving, by the computer, from a personal mobile electronic device located in the vicinity of the printer, an identifier of the printer and an identification of the personal mobile electronic device, the identifier having been retrieved from a token located in the vicinity of the printer; checking, by the computer, whether the identification is valid; and if the identification is valid, transmitting a command to the printer to cause it to start printing the document.

Still further disclosed is one or more non-transitory computer readable media comprising computer readable instructions that, when executed by one or more processors cause one or more computers to: receive an instruction to print a document; receive, from a personal mobile electronic device located in the vicinity of a printer, an identifier of the printer and an identification of the personal mobile electronic device; check whether the identification is valid; and if the identification is valid, transmit a command to the printer to cause it to start printing the document.

### BRIEF DESCRIPTION OF THE DRAWINGS

The drawings illustrate embodiments of the invention, but should not be construed as restricting the scope of the invention in any way.

FIG. 1 shows a system for delaying operation of a printer until a user is in its vicinity.

FIG. 2 shows an application in and identification of a personal mobile electronic device.

FIG. 3 is a flowchart of a process for starting operation of a printer when a user is in its proximity.

FIG. 4 is a flowchart showing further steps in the process for starting operation of a printer when a user is in its proximity.

FIG. 5 is a flowchart of an alternate process for starting operation of a printer when a user is in its proximity.

FIG. 6 is a flowchart of an optional process in which the user is required to respond to a challenge.

FIG. 7 is a flowchart of a process for printing a document in stages.

FIG. 8 shows a personal mobile device with a single-use digital token.

FIG. 9 is a flowchart of a process for starting a printer using a single-use digital token.

FIG. 10 is a flowchart of another process for starting a printer using the single-use digital token.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated. It will be further appreciated that the line between hardware and software is not always sharp, it being understood by those skilled in the art that software implemented processes may be embodied in hardware, firmware, or software, in the form of coded instructions such as in microcode and/or in stored programming instructions.

### Printer Token

A printer token, which may be referred to simply as a token, is a unique, passive identifier for a printer. Being passive, it does not need to be powered, and does not need any electrical connection to it. It may be placed on a printer, adjacent to it, inside it or generally in its vicinity, such that a user detecting it is within reach of documents printed by the printer to which it is attached. A printer token can take on any form, so long as it is passive and can uniquely identify the printer to which it is associated. Examples of such printer tokens are QR codes and NFC chips. Ideally, they should be securely attached to or embedded in the printer or fixed to a nearby surrounding part of the room in which the printer is securely fastened, such that their removal is difficult without damage. If the printer token is embedded, and it is not evident as to where it is, there should be an external marker to show users where it is. Other forms of identification and/or other types of technology may be used to identify a printer. For example, traditional bar codes may be used.

### Digital Token

A digital token is a soft, electronic or virtual token that does not have any macroscopic physical form and typically exists in general purpose electronic storage media that is also used for storing other data. Such storage media may be electronic memory found in a server or a personal mobile device, such as a smart phone for example. Digital tokens can be transmitted between a server and a user's personal mobile electronic device via a network such as the Internet, a telecommunication network, or both.

### Personal Mobile Device

A personal mobile device may be a smart phone, a tablet computer, an iPod™ mobile digital device or any other electronic communication device carried or worn on the person that can additionally be used for detecting a printer token, reading a printer token, or both. For example, the personal mobile device may incorporate a camera that can capture an image of a QR code. As another example, the personal mobile device may incorporate an NFC module that can detect and read NFC tags that are in close proximity to the electronic device. Other technologies may be incorporated in the personal mobile devices that detect and/or read printer tokens using other technologies. The main requirements of the personal mobile device are that it can detect printer tokens and communicate with a remote server. Optionally, the mobile device may be configured to capture biometric or other data and transmit this to the server as well, permitting the system to make use of multi-factor authentication.

### Printer Control

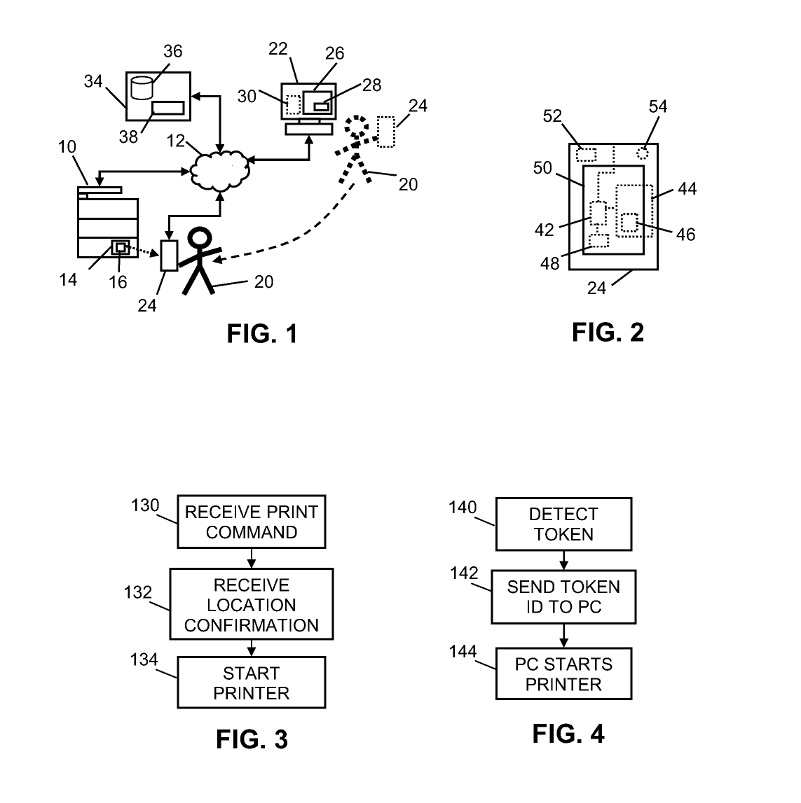

Referring to FIG. 1, a system is shown for facilitating the secure operation of printers 10 (for sake of simplicity only one printer being shown) that are connected to a network 12. The network 12 may be an Ethernet, the Internet, a telecommunications network or any combination thereof. Each printer 10 that is to be controlled in this way has a token 14 attached to it, the token containing a unique identifier 16. Examples of tokens include NFC chips, QR codes and bar codes, but other types of token may equally be used. The token is ideally fixed to the printer so that it is difficult or impossible to remove. It is also ideally an unpowered token, so that connection to the printer's power source or an additional power source is not required.

Before requesting a document to be printed, a user 20 may be sitting at one of numerous desks in a shared office, working at a personal computer 22 at a distance from the printer 10. The user will normally have a personal mobile electronic device 24, such as a smart phone, close at hand. When the user wants to print a document, a printer control window 26 is displayed on the personal computer 22, the window containing an OK button 28 which is typically used for starting the printer 10. However, when the user 20 clicks on the OK button 28, the printer 10 does not automatically start due to the application 30 temporarily blocking it. Instead, the user 20 must walk over to the printer 10 with his personal mobile device 24 and use his personal mobile electronic device to detect the identifier 16 in the token 14 on the printer.

A personal mobile device 24 that is carried by a user 20 wishing to print a document is shown in FIG. 2. The personal mobile device 24 includes one or more processors 42, memory 44, one or more applications 46 stored in the memory, a unique identification 48, and user interface 50, which may be a multi-touch screen, for example. Also included is an NFC reader 52 and/or a camera 54. The camera 54, for example, may be used to take a snapshot of printer token 14, if the printer token is a QR code. The application(s) 46 may interpret the unique printer code contained in the QR code and transmit the unique printer code and the unique identification 48 of the personal mobile device via a communication link and via the network 12 to server 34 (FIG. 1).

The application(s) 46 may be configured in many different ways. They may transmit the QR code to the server 34 or personal computer 22 for interpretation there. They may be configured to automatically detect the presence of a QR code in the field of view of the camera 54, subsequently take a photo of it and then automatically send it and an identification of the personal mobile device to the server 34. Alternately, the application(s) 46 may be configured such that a user must enter a PIN code or a password in the mobile device before the application opens and is able to capture an image or reading of the printer token. As a further alternative, the application may be configured to capture biometric data, such as a user's fingerprint, iris or facial features. Such biometric data would previously be stored in a database 36 to which the server 34 has access. The biometric data would then be sent to the server 34 together with the personal mobile device identification 48 and the printer identifier so that all three can be used by the server to make a decision as to whether to allow the printer to print. The location of the personal mobile device may also be determined and sent to the server 34 as a further factor in the authentication process. Location may be determined by GPS-based means, Wi-Fi trilateration, femtocell detection, RF signal strength detection or any other means appropriate for indoor location determination.

The application(s) 46 may be configured to read a single type of token or multiple different types (e.g. both QR codes and NFC chips). The same application(s) 46 may be used for multiple printers. In some cases, a fee may be automatically charged to a user's account when he uses the application 46 to print a document.

The unique identification of the personal mobile device 24 may be a MAC address, for example, stored in firmware or hardware memory, it may be derived from the MAC address, or it may be assigned to the personal mobile device by the server 34 and stored in the memory 44. The server 34, upon receipt of the unique identification of the personal mobile device 24 decides whether to send a start command to the printer 10, based on whether the user of the personal mobile device 24 has been authorized to use the printer 10. For this, the details of the user and the unique identification 48 of the user's personal mobile device 24 are previously associated in a database 36 in the server 34, together with permission levels for that user to use the printer. If the user has been granted permission to use the printer 10, the server 34 forms an IP packet containing the start printer signal and sends it to the printer 10, which then starts printing.

Requiring detection of the identifier 16 in the token 14 ensures that the owner or user 20 of the personal mobile device 24 is next to or near enough to the printer 10 to retrieve any printed documents before other people can read them.

Upon detecting the token 14, the identifier 16 contained in the token and an identification of the personal mobile device 24 may be sent by the personal mobile device to the server 34, which then sends a start print command to the personal computer 22. The application 30 in the personal computer 22 functionally in communication with the printer control software in the personal computer then unblocks the OK button 28, allowing it to function traditionally and causing the printer 10 to start printing.

Referring back to FIG. 1, in an alternative system, an application 38 in the server 34 may be sent the print job, or details of it, when the user 20 clicks on the OK button 28. Upon detection of the token 14, the identifier 16 in the token may be transmitted by the personal mobile device 24 to the server 34. The server 34 is configured to check the validity of the identifier 16 and the identification 48 of the personal mobile device 24, and match it with the print job, which may be one of several jobs in a queue for the printer 10. A database 36 in the server 34, or elsewhere where the server can access it, contains identifiers of printers and identifications of personal mobile devices that can be cross-checked with identifiers and identifications received from users' personal mobile devices 24 when a printer is required to start printing. Provided the printer identifier 16 and mobile device identification 48 received are valid, the server 34 either instructs the printer 10 to start printing or sends a command to the personal computer 22 that causes it to issue the print command, effectively releasing the apparent block on the OK button 28.

Referring to FIG. 3, a flowchart is shown for delaying the start of a printer until a user instructing the printer is in its vicinity. In step 130, the system receives a print command. This may be by way of a user 20 clicking an OK button 28 on the screen of a personal computer 22. There are other ways in which this can be achieved. In step 132, the system receives confirmation that the location of the user 20 is in proximity to the printer 10. As described above, this may be by way of the user 20 detecting an identifier 16 in a token 14 attached to the printer 10 and sending it to a server 34 or the personal computer 22. Other location technology may alternately be employed. After confirmation of proximity is received, the printer is commanded to start printing, in step 134.

Referring to FIG. 4, a flowchart showing more steps in the process is shown, after the user has initiated the request for a print. In step 140, the user's mobile device 24 detects the token 14 on the printer 10. In step 142, the personal mobile device 24 sends the identifier 16 in the token 14 to the personal computer 22. In step 144, the personal computer 22 sends a command to the printer to cause it to start printing.

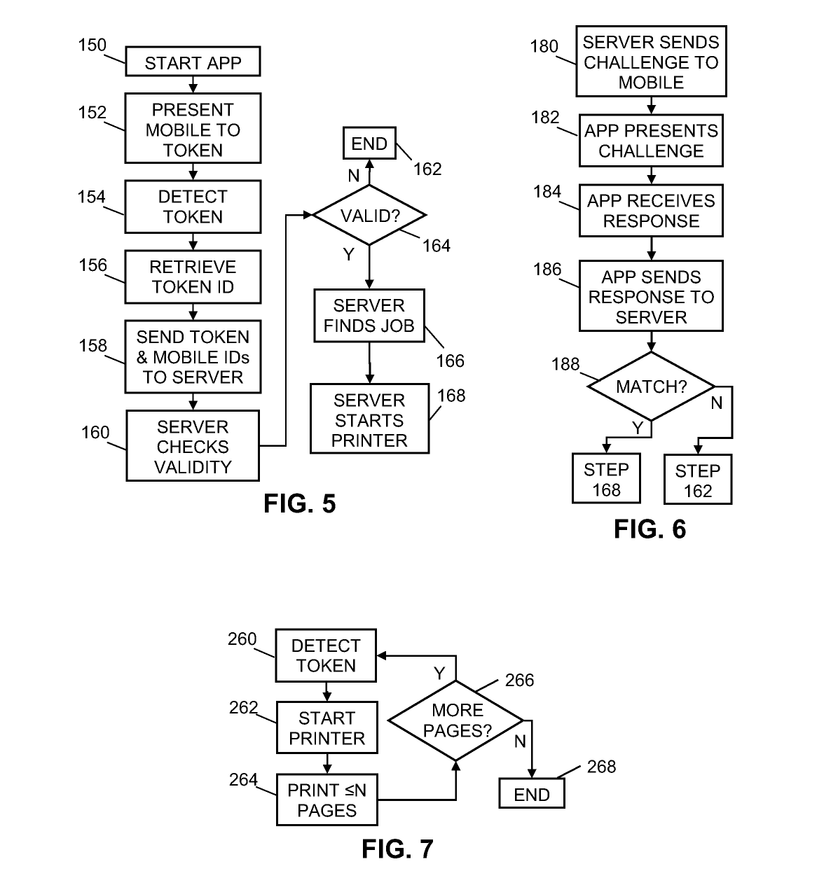

FIG. 5 is a flowchart of an alternate process for starting operation of a printer when a user is in its proximity. In step 150 an application 46 on the personal mobile device 24 is started. In step 152, the personal mobile device is presented to the token on the printer. In step 154 the token 14 on the printer is detected, the identifier 16 in the token is retrieved in step 156 and the identifier is sent to the server 34 in step 158, together with an identification 48 of the user's personal mobile device 24. In step 160, the server checks the validity of the received token identifier and mobile device identification. If, in step 164 the identifier and identification be invalid, the process ends at step 162. However, if in step 164 the identifier and identification be valid, the server 34 searches for and finds the requested print job if present, in step 166. Upon finding the requested print job, the server 34 sends a command to the printer 10 to start printing in step 168.

In FIG. 6 a flowchart is shown of optional steps that may be taken by the system if a greater level of security is required. These steps may also be useful, for example, when members of the public who do not have a suitable printer at home wish to use a printer in a print shop. The optional steps may be performed, for example, after step 166 and before step 168. In step 180, the server, upon determining that the user has been granted permission to use the printer, sends a challenge to the personal mobile device 24. This may be a request to provide biometric data or to enter a password, part of a password, a PIN code, part of a PIN code, a response to a predetermined question to which the user has previously provided answers, a response to a picture displayed on the mobile device, or any other challenge. In step 182, the application 46 presents the challenge to the user, receives the response to the challenge in step 184, and transmits the response to the server 34 in step 186. The server 34, in step 188, determines whether there be a match between the transmitted response and the expected response as stored or calculated at the server. If there not be a match, the process reverts to step 162, in which operation of the printer denied. However, if there be a match in step 188, the process reverts to step 168, in which a start printer signal is sent to the printer 10.

FIG. 7 is a flowchart of the main steps of a process for printing a document in stages. While many confidential documents are only one or a few pages long, there may be some documents that are significantly longer. Policies may be used by companies to induce employees to stand by printers while they are printing. However, to allow for the chance that a user may wander away from the printer while it is printing a long document, the document may be printed in stages, the proximity of the user being confirmed for each stage. In step 260, the user's personal mobile device 24 detects the token 14 and as a result the printer is started in step 262. In step 264, the printer prints up to a predetermined integral number of pages, N. After these pages are printed, the printer stops, and in step 266 the system determines whether there are any more pages still to be printed in the document. If there are more pages, which may be waiting in a separate printing file, the system waits until the printer token 14 is detected again, in step 260, which confirms that the user is still in proximity of the printer. If user proximity to the printer is once again confirmed, printing starts again, in step 262, and another set of up to N pages is printed. If there be no more pages after a set of up to N pages has been printed, the process ends, at step 268.

### Single-Use Digital Tokens

A further embodiment includes the facility to allow one-time use of a printer. This may be useful for visitors to an establishment, for temporary workers, or for members of the public using a print shop. In this embodiment, a digital token (i.e. an electronic, soft or virtual token as opposed to previously described tokens which have a macroscopic physical form such as a QR code or NFC chip) is sent to the user's personal mobile electronic device to be used for use of a particular printer. One advantage of such digital tokens is that the administrator of the system does not need to assign the users to access groups in order for them to use the printers.

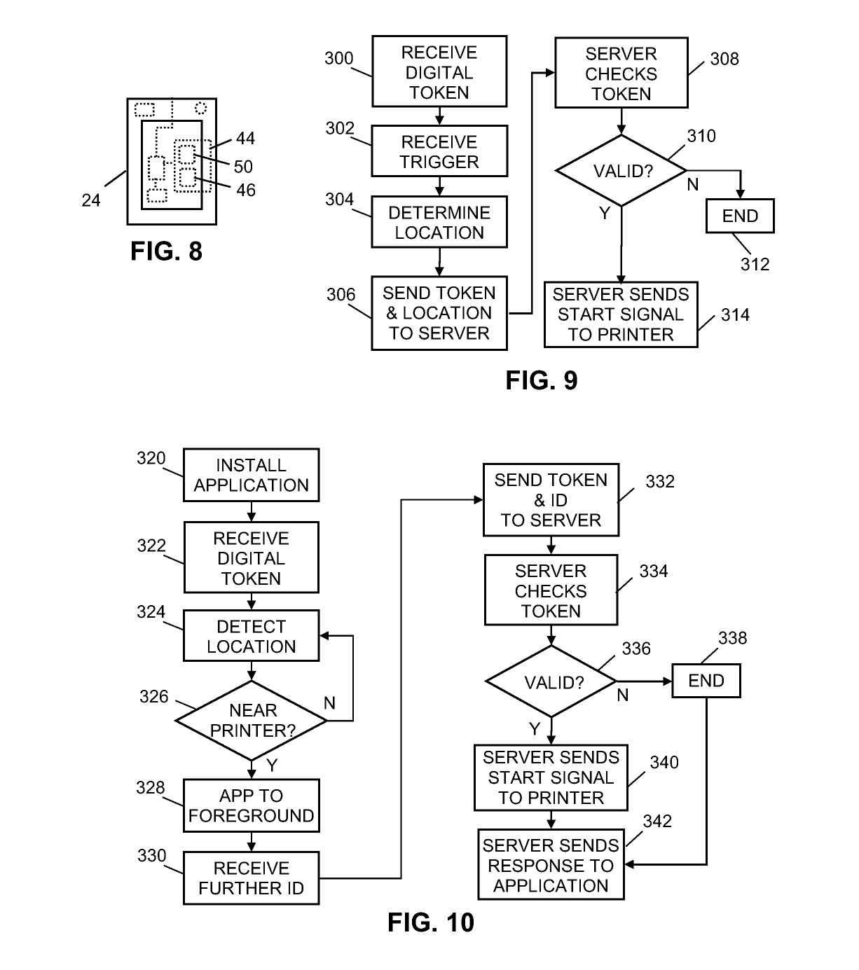

Referring to FIG. 8, this embodiment includes the capability of sending a one-time digital token 50 to the user's personal mobile device 24, where it is stored in memory 44. The one-time digital token 50 may be sent to the device 24 from the server 24 or other computer by email, SMS, push message or any other appropriate means. The application 46 may still be present, as the user may use it to access printers at a normal place of business, or it may be needed to capture the printer token 14 for the printer 10 for which one-time use is desired.

Referring to FIG. 9, a flowchart of a process is shown for the use of a one-time digital token 50. In step 300, the personal mobile device 24 receives a digital token, by email, SMS or a push message, for example. The digital token 50 corresponds to a particular printer and may also correspond to a particular time, time interval or day, The digital token 50 may also contain information relating to a unique identification of the user's personal mobile device 24. In step 302, the personal mobile device receives a trigger indicating that the user wants to start the printer. The trigger may be the detection by the personal mobile device 24 of a printer's QR code 16 or NFC code, for example. The trigger may be a click by the user on a link provided to the personal mobile device with the digital token 50. On receipt of the trigger, the personal mobile device 24 determines its own location in step 304, using RF signal strength detection, for example. However, this may not be necessary if the identifier 16 on the printer token 14 is captured, which will have the effect of determining the location of the user's mobile device 24. Upon receiving the trigger and determining the location of the user's mobile device 24, the mobile device sends the digital token 50 and location information to the server 34, in step 306. Next, in step 308, the server 34 checks the validity of the digital token 50, which may be a check in relation to one or more of the time of day, the location of the user's personal mobile device and the identity of the user's personal mobile device. If, in step 310, the digital token be found to be invalid, printer use is denied in step 312. If, however, the digital token 50 be valid, then in step 314 the server sends a start signal to the printer, via a network 12.

The single-use digital token 50 may be used with additional security measures. For example, as well as the user being in the correct location, the user may be sent a challenge to which a correct response is required, as described in relation to FIG. 6. In this case the application 46 should be installed on the user's mobile device 24.

Referring to FIG. 10 to another embodiment, in step 320, the application 46 is installed in the user's mobile device 24. In step 322, the user's mobile device receives the digital token. In step 324, the location of the printer, or more accurately, the location of the user's mobile device 24 is detected. This may be by way of detecting a printer token 14, but in other cases it may be by other location detection technology. If, in step 326, the user not be near the printer, then the application 46 will revert to detecting the location of the user's mobile device 50 at a later time. However, if the user be near the printer, then the application 46 is brought to the foreground in step 328 and the user is prompted to enter further identifying information in step 330. Alternately, the application may be brought to the foreground upon receiving a message from the server 34 after a print request has been initiated by the user. Then, in step 332, the user's mobile device sends the digital token 50 and further identification 48 to the server 34. Such further identification may be a PIN or password. However, instead of the further identification, confirmation of identification resulting from a valid biometric input to the user's device may be sent to the server 34. Next, in step 334, the server 34 checks the validity of the digital token 50. If, in step 336, the digital token be found to be invalid, printer use is denied in step 338. If, however, the digital token 50 be valid, then in step 340 the server 34 sends a start command to the printer via network 12. Whether printer use is denied or allowed, a response message is sent to the user's mobile device 24 in step 342, to indicate whether printer use is denied or allowed.

Another way of providing a challenge, without the user needing to install the application 46, would be to provide a link with the digital token 50, the link taking the user to a webpage where they are required to enter a PIN or other one-time password.

### Variations

As can be appreciated, there are other different ways in which this delayed printer operation can be achieved. The main requirement is that the printer 10 start printing only when the user 20 has confirmed his proximity to the printer by capturing an identifier 16 on the printer and sending it to a printer control application.

The user's mobile device 24 and the personal computer 22 may be one and the same thing, and a button on the personal mobile device may be clicked instead to make the print request.

There are a number of ways to trigger the printer activation from the user's mobile device. The trigger could be a voice command, in combination with location. The user may start up the application 46 on the phone and just say, for example, “start printing”. Provided the user's location is verified and access is allowed, the printer will be started. If the user's mobile device has a location service installed it can start the application 46 automatically when the user reaches a certain location coordinate and the user would just push an on-screen button displayed on the device to start the printer. The point is that the actual triggering of the printing can be any kind of action or combination of actions, including one or more of a QR-scan, an NFC scan, entry of a PIN, a clicked link, a gesture, a fingerprint, the pushing of a soft button, a voice command, voice recognition, face recognition, location detection, etc.

In an alternate embodiment, both a QR code and an NFC chip may be used to identify the same printer.

The personal computer 22 and the server 34 may be one and the same computer, or may be a network of several computers. A network of computers performing the functions of the personal computer 22 and the server 34 may simply be referred to as a computer.

Alternately, or additionally, communications may be sent from the server to the user's personal mobile device 24 at any time to indicate to the user whether printer use is granted or denied or whether the user should go to the printer to initiate document printing. Indication to the user may be visual, textual or audible, or any combination of these.

### INDUSTRIAL APPLICABILITY

Printers may be controlled such that confidential documents are only printed in the presence of the users requesting them to be printed.

As will be apparent to those skilled in the art, and in light of the foregoing disclosure, many further alterations and modifications are possible in the practice of this invention without departing from the scope thereof. The steps of the process described herein may be performed in a different order to that shown, they may be performed differently, or some may be omitted while still achieving the same objective. Likewise, the steps taken by the application 46 may be performed in a different order to that described.

Steps from one flowchart may be switched or combined with steps in others of the flowcharts. Accordingly, the scope of the invention is to be construed in accordance with the substance defined by the following claims:

1. A system for controlling printers comprising:
a printer;
an unpowered token comprising an identifier for, and located in the vicinity of, the printer; and
a computer connected to the printer and configured to generate commands for said printer;
wherein the computer is configured to:
receive an instruction to print a document;
receive, from a personal mobile electronic device located in the vicinity of the printer, the identifier and an identification of the personal mobile electronic device;
check whether the identification is valid; and
if the identification is valid, transmit a command to the printer to cause it to start printing the document.

2. The system of claim 1 wherein the token is a quick response code.

3. The system of claim 1, wherein the token is a near field communication chip.

4. The system of claim 1, wherein the computer is further configured to:
send a challenge to the personal mobile electronic device;
receive a response from the personal mobile electronic device;
determine whether the response is a correct response; and
transmit said command conditionally upon the response being a correct response.

5. The system of claim 1, wherein the computer includes a server configured to:
receive biometric data from the user of the personal mobile electronic device, said biometric data having been obtained by the personal mobile electronic device;
determine whether the biometric data corresponds to previous biometric data stored and related to the user in a database; and
transmit said command conditionally upon the biometric data corresponding to the previous biometric data.

6. The system of claim 1, wherein if the identification is invalid, send a message to the personal mobile electronic device indicating that printing is denied.

7. The system of claim 1, wherein the computer includes a server configured to:
receive, from a second personal mobile electronic device located in the vicinity of the printer, a digital token relating to said printer;
check whether the digital token is valid; and
if the digital token is valid, transmit a command to the printer to cause it to start printing.

8. The system of claim 1, wherein the computer is remote from the printer.

9. The system of claim 1, wherein the computer is a server and receives said instruction via a personal computer.

10. The system of claim 9, wherein said command is transmitted via the personal computer.

11. The system of claim 1, wherein the document is a first part of a larger document and the computer is further configured to:
receive again, from the personal mobile electronic device located in the vicinity of the printer, the identifier and the identification of the personal mobile electronic device;
check again whether the identification is valid; and
if the identification is again valid, transmit a command to the printer to cause it to start printing a second part of the larger document.

12. A method for controlling printers comprising:
receiving, by a computer remote from a printer, an instruction to print a document;
receiving, by the computer, from a personal mobile electronic device located in the vicinity of the printer, an identifier of the printer and an identification of the personal mobile electronic device, said identifier having been retrieved from a token located in the vicinity of the printer;
checking, by the computer, whether the identification is valid; and
if the identification is valid, transmitting a command to the printer to cause it to start printing the document.

13. The method of claim 12, wherein the token is a quick response code or a near field communication chip.

14. The method of claim 12, further comprising:
sending a challenge from the computer to the personal mobile electronic device;
receiving, by the computer, a response from the personal mobile electronic device;
determining, by the computer, whether the response is a correct response; and
transmitting said command conditionally upon the response being a correct response.

15. The method of claim 12, further comprising:
receiving biometric data from the user of the personal mobile electronic device, said biometric data having been obtained by the personal mobile electronic device;
determining, by the computer, whether the biometric data corresponds to previous biometric data stored and related to the user in a database; and
transmitting said command conditionally upon the biometric data corresponding to the previous biometric data.

16. The method of claim 12, further comprising:
receiving, from a second personal mobile electronic device located in the vicinity of the printer, a digital token relating to said printer;
checking whether the digital token is valid; and
if the digital token is valid, transmitting a further command to the printer to cause it to start printing.

17. The method of claim 12, wherein the computer comprises a server and a personal computer.

18. One or more non-transitory computer readable media comprising computer readable instructions that, when executed by one or more processors cause one or more computers to:
receive an instruction to print a document;
receive, from a personal mobile electronic device located in the vicinity of a printer, an identifier of the printer and an identification of the personal mobile electronic device;
check whether the identification is valid; and
if the identification is valid, transmit a command to the printer to cause it to start printing the document.

19. The non-transitory computer readable media of claim 18, comprising further computer readable instructions that cause:
sending a challenge from the computer to the personal mobile electronic device;
receiving a response from the personal mobile electronic device;
determining whether the response is a correct response; and
transmitting said command conditionally upon the response being a correct response.

20. The non-transitory computer readable media of claim 18, comprising further computer readable instructions that cause:
receiving biometric data from the user of the personal mobile electronic device, said biometric data having been obtained by the personal mobile electronic device;
determining whether the biometric data corresponds to previous biometric data stored and related to the user in a database; and
transmitting said command conditionally upon the biometric data corresponding to the previous biometric data.
